(19) United States
(12) Patent Application Publication
(10) Pub. No.: US 2024/0052251 A1
(43) Pub. Date: Feb. 15, 2024

(54) Surface Slipping Agents for Improving Flow

(71) Applicant: Paul Robert Hart, League City, TX (US)

(72) Inventor: Paul Robert Hart, League City, TX (US)

(21) Appl. No.: 17/819,650

(22) Filed: Aug. 15, 2022

(51) Int. Cl. C10G 75/04; C09K 8/528; C09K 8/524

(52) U.S. Cl. CPC C10G 75/04; C09K 8/528; C09K 8/524; C10G 2300/80; C10G 2300/4075

(57) ABSTRACT

Methods are described for improving flow of oil containing fluids through vessels, pipelines, heat exchangers, and other equipment. Polymeric surfactants with lipophilic head groups and long hydrophilic poly(ethene oxide) tails are added to the fluid to coat the oil and metal surfaces with drag reducing aqueous filaments, allowing the oil to slip past those surfaces without sticking and with little resistance. Such surface coatings also promote coalescence of viscous emulsions of water-in-oil or oil-in-water without creating oil-wet flow blocking residues on stationary surfaces. Such fouling obstructs the flow of oil and water and results in both material and energy losses.

### CROSS-REFERENCE TO RELATED APPLICATIONS

None

### STATEMENT REGARDING FEDERALLY SPONSORED RESEARCH OR DEVELOPMENT

None.

### FIELD OF THE INVENTION

The present invention relates to improving the flow of multiphase oilfield and industrial process fluids though reservoirs, pipes, vessels, and other conduits and equipment.

### BACKGROUND OF THE INVENTION

The flow of multiphase oilfield and industrial process fluids though reservoirs, pipes, vessels, and other conduits and equipment can be impeded by fouling of the surfaces with sticky viscous or solid deposits, interference of flow by dispersed particles, and turbulent drag or friction near stationary surfaces. Surface active agents added to the flowing fluid can improve flow by coating these dispersed and/or stationary surfaces in such a way as to provide a thin, slippery layer of water on that surface.

Oil wet residues or surfaces can foul productive geological reservoirs, production tubing, flowlines, valves, chokes, separation vessel bottoms, heat exchanger internals, hydrocyclone reject outlets, flotation paddles, and reinjected geological reservoirs. Such residues can also foul minerals, like sand, clay, and scale, carried in produced water or through which the produced fluid is carried.

Conventional ionic surfactants are more soluble in water hot than cold. But calcium carbonate and calcium carboxylate (naphthenate) foulants have “inverse solubility”, i.e. are more soluble cold than hot. The hot side of a heat exchanger will thus have more foulant than surfactant on the surface and the cold side will have more surfactant than foulant. To balance the demand for surfactant with the supply of foulant, the surfactant must also have inverse solubility. Poly(ethylene glycol) (PEG) has inverse solubility.

Conventional turbulent drag reduction polymers need troublesome and expensive predilution to less than 1% active to enable their ready addition and diffusion into liquid streams. Much of the polymer added ends up being broken down outside the turbulent transition zone near the surface.

Conventional cationic acrylic ester or amide based polymers that will stick to and concentrate near the surface are not hydrolytically stable at the high temperature of steam condensate production and refinery desalter effluent brines, or in high pH alkali production floods and refinery and petrochemical caustic extraction units, and in low pH acid stimulation well flowbacks and refinery alkylation units. Conventional nonionic and polyacrylamide or anionic poly(acrylic acid) based flow improvement polymers do not concentrate near the surface and are readily degraded with common oxidizing chemicals, including hypochlorite bleach and hydrogen peroxide.

### BRIEF SUMMARY OF THE INVENTION

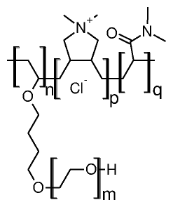

The surface slipping agents of the invented method comprise a class of polymeric “reverse surfactants”, those with lipophilic heads and hydrophilic tails. In this case, the heads are also cationic to promote adhesion to anionic oil and metal surfaces. Such compositions can be made, for example, by polymerization of vinyl monomers containing long chains of hydroxy-terminated poly(ethylene oxide), such as vinyl-PEG5000, with aprotic nonionic and cationic vinyl monomers, such as dimethylacrylamide (DMA) and diallyl dimethyl ammonium chloride (DADMAC), as shown in FIG. 1. Terpolymers of this type, known as “shine polymers”, are manufactured commercially for use in bathroom cleaning formulations, to make bathroom fixtures shinier. One example is Aristocare® Smart from Clariant, the composition and prior use of which is described in German patents DE 102,016,223,586; 102,016,223,588; 102,016,223,589; and 102,016,223,590, herein incorporated by reference.

Not to be bound by any theory, these surface slipping agents are believed to improve flow by adhering tenaciously to the anionic surfaces of oil droplets, mineral particles, and vessel surfaces in contact with at least a thin film of water, through a combination of their cationic charge and aprotic lipophilicity; while the pendant, hydrophilic tails provide a hyperextended hydration layer, rendering and keeping the surfaces water wet and slippery. Surface-fouling materials carried by water, such as oil, oily solids, organo-silicates, naphthenates, and mineral scales, which would otherwise have stuck to and fouled the vessel or particle surface, are easily swept away with the water flow when these agents are fed to the flowing fluid. This hydration layer also reduces drag inducing turbulent flow in the vicinity of the surface, allowing water to flow more efficiently along the surface, resulting in reduced pressure drop and improved heat exchange.

These reverse surfactants, due to the inverse solubility polyether chains, also exhibit conformational changes in which adsorption on surfaces and solubility in water both rise and fall in synchrony with changes in fluid temperature, making them particularly appropriate for use ahead of or into heat exchangers, by ensuring a homogeneous coating throughout the exchanger, whether heating or cooling. This prevents redeposition of foulants downstream of the inlet.

Unlike conventional drag reduction polymers, which need expensive predilution to 2 to 0.2% active to enable their ready addition and diffusion into liquid streams, the highly branched structure of these polymers allows them to be packaged dissolved in water at high concentrations of 25-30% and still have low viscosities of 20-40 cP, which allows direct injection without dilution.

Unlike conventional acrylic ester-based polymers, the terpolymers of the present invention are hydrolytically stable in high temperature steam condensate production and refinery desalter effluent brines, in high pH alkali production floods and refinery and petrochemical caustic extraction units, and in low pH acid stimulation well flowbacks and refinery alkylation units. Unlike conventional polyacrylamide-based flow improvement polymers, they are stable in situ toward most oxidizing chemicals, including hydrogen peroxide.

These materials are chemically compatible with other commonly used oilfield and refinery chemicals, including cationic surfactants used in corrosion inhibitors, hydrate inhibitors and biocides; nonionic surfactants used in emulsifiers, non-emulsifiers, demulsifiers, and paraffin inhibitors; cationic salts and polymers used in reverse emulsion breakers, deoilers, clarifiers, and dispersants; and even with the anionic surfactants used in some asphaltene inhibitors, dispersants, and demulsifiers.

The method comprises adding a terpolymer of the present invention to a produced or process fluid which contains or will contain oil, solids, or both, and at lease enough water to form a thin film on the vessel surface. Thus, the ratio of stationary water to continuous process flow can be arbitrarily small. Addition can be upstream of a flowline, phase separation unit, or heat exchanger to improve flow therein. It can be added with or to a cleaner, dispersant, antifoulant, demulsifier, or reverse demulsifier formulation, or directly into the flowing fluid by itself.

The terpolymer is added in an amount effective for keeping the oil separated from the solids and the surfaces yet allowing the oil droplets to coalesce with each other and with any bulk oil in the fluid. Dosage per treated fluid might typically be 5-20 ppm for most applications but could be as low 1 ppm or as high as 100 ppm for others. Concentrated treatments above 100 ppm up to 10,000 ppm (1%) may be needed in certain batch or surface pre-treatment applications.

### BRIEF DESCRIPTION OF THE DRAWINGS

Drawing 1 shows the general structure of a polymeric cationic-lipophile-headed, nonionic-hydrophile-tailed, reverse surfactant used as a surface slipping agent. In this structure, n can be 1-10, m can be 25 to 250, and (p+q) together can be 4 to 100.

### DETAILED DESCRIPTION OF EXEMPLARY EMBODIMENTS OF THE INVENTION

### Material Tested

The surface slipping agent tested, dubbed “ShineOn”, is a 26% aqueous solution of a terpolymer of vinyl PEG 5000, diallyl dimethyl ammonium chloride, and dimethyl acrylamide, sold as a bathroom shine polymer by Clariant as Aristocare® Smart. This was tested in a series of process challenges in place of, or in addition to, conventional flow improvers and oil/solids dispersants.

### Mineral Scale Antifoulant

250 mg of a conventional solids dispersant, a solution of citric acid and nonionic surfactants, was applied to a black oxide-surfaced coupon. The same solution with only 0.5 mg of ShineOn added was applied to a duplicate coupon. After drying, 100 mL hard water was applied to the coupons and allowed to evaporate until mineral deposits formed. The coupon not treated with ShineOn had 5 times more mineral deposits stuck to it, scoring a visual cleanness rating of 2 out of 5 (where 1 is completely covered and 5 is completely clean), compared to a rating of 4.3 for coupon treated with ShineOn.

### Calcium Naphthenate Antifoulant

250 mg of a conventional solids dispersant, a solution of citric acid and nonionic surfactants, was spread with a cloth on one half of a black oxide-surfaced coupon. The same solution with only 0.5 mg of ShineOn added was spread on the other half. A synthetic calcium naphthenate was generated in situ by spreading a CaCl2) solution followed immediately by a fatty acid sodium salt solution. After 5 min drying, the synthetic Ca naphthenate fouling was baked on for 1 h at 60° C., simulating the surface of a heat exchanger. The coupon was then allowed to cool and rinsed with 100 mL water to simulate the flow of water past the surface. Essentially none of the synthetic Ca naphthenate on the side untreated with ShineOn was removed. That entire half of the coupon was still completely coated. Essentially all the synthetic Ca naphthenate on the side treated with ShineOn was removed. That entire half of the coupon was completely clean.

### Surface Flow Improver

500 mg of a conventional dispersant, a solution of citric acid and nonionic surfactants, was spread with a cloth on a black oxide-surfaced coupon. The same solution with only 1.0 mg of ShineOn added was spread on another coupon. After 30 minutes drying, the coupons were inclined by 14° and rinsed for 2 seconds with tap water at a flow rate of 100 mL/s. The time each coupon took to drain the water was measured. The coupon treated with ShineOn drained completely dry in less than 10 seconds. After 60 minutes, when the test was stopped, the untreated coupon was still mostly wet and only slowly draining.

### Oily Surface Antifouling at Extreme pH

To test its effectiveness under extreme oilfield conditions, including acid stimulation flowbacks and alkaline surfactant floods, 500 mg of three different conventional dispersants, covering a range from acid to alkaline conditions, were spread with a cloth on a black oxide-surfaced coupon. To simulate acidizing well stimulation flowbacks, Dispersant A, a solution of citric acid and nonionic and anionic surfactants with a pH of 3, was used. To simulate alkali surfactant floods, Dispersant B, a solution of caustic and nonionic and cationic surfactants with a pH of 12, was used. To simulate normal production, Dispersant C, a solution of nonionic surfactants with a pH of 6, was used. These were compared on duplicate coupons to the same solutions with 1.0 mg of ShineOn added. After 30 minutes drying at room temperature, the coupons were inclined by 14° and rinsed for 2 seconds with oily water at a flow rate of 100 mL/s. Fouling (streaking) of the coupon was evaluated by a visual rating of 5 replicates on a scale from 1-10, with 1=no fouling and 10=worst fouling. These rating are listed below.

TABLE 1
Coupon Fouling with and without ShineOn

| Label | Rating | Treatment Applied | Treatment Description |
|---|---|---|---|
| A | 8.0 | 500 mg | Solution of citric acid, |
| | | Dispersant A | nonionic, and anionic - pH 3 |
| A + SO | 3.3 | 500 mg | |
| | | Dispersant A + | |
| | | 1 mg ShineOn | |
| B | 10.0 | 500 mg | Solution of nonionic and |
| | | Dispersant B | cationic surfactants - pH 12 |
| B + SO | 2.8 | 500 mg | |
| | | Dispersant B + | |
| | | 1 mg ShineOn | |
| C | 9.4 | 500 mg | Solution of nonionic |
| | | Dispersant C | surfactants - pH 6 |
| C + SO | 2.2 | 500 mg | |
| | | Dispersant C + | |
| | | 1 mg ShineOn | |

In all cases, ShineOn radically reduced the fouling, improving the ratings an average of 6.4 points, from 9.1, untreated, to 2.8, treated with ShineOn.

I claim:

1. A method for improving flow of oil containing fluids through production and process vessels, pipelines, heat exchangers, and other equipment by adding polymeric surfactants with lipophilic head groups and long hydrophilic poly(ethylene oxide) tails.

2. A method of claim 1 where such polymeric surfactants are vinyl polymers comprised of vinyl monomers containing long chains of hydroxy-terminated poly(ethylene oxide) and aprotic cationic or nonionic vinyl monomers.

3. A method of claim 2 comprising both cationic and nonionic aprotic vinyl monomers.

4. A method of claim 2 where such vinyl monomers containing long chains of hydroxy-terminated poly(ethylene oxide) comprise vinyl-PEG of PEG molecular weight from about 1000 to about 10,000.

5. A method of claim 4 where such vinyl-PEG has PEG molecular weight of about 4000 to about 6000.

6. A method of claim 2 where such aprotic nonionic vinyl monomers comprise dialkylacrylamides.

7. A method of claim 2 where such aprotic cationic vinyl monomers comprise diallyl dialkyl ammonium cations.

8. A method of promoting coalescence of emulsions of water-in-oil or oil-in-water without creating oil-wet flow blocking residues on stationary surfaces by adding polymeric surfactants with lipophilic cationic head groups and long hydrophilic poly(ethene oxide) tails.

9. A method of claim 8 where such polymeric surfactants are vinyl polymers comprised of vinyl monomers containing long chains of hydroxy-terminated poly(ethylene oxide) and aprotic cationic or nonionic vinyl monomers.

10. A method of claim 9 comprising both cationic and nonionic aprotic vinyl monomers.

11. A method of claim 9 where such vinyl monomers containing long chains of hydroxy-terminated poly(ethylene oxide) comprise vinyl-PEG of PEG molecular weight from 2000 to 10,000.

12. A method of claim 11 where such vinyl-PEG has PEG molecular weight of 4000 to 6000.

13. A method of claim 9 where such aprotic nonionic vinyl monomers comprise dialkylacrylamides.

14. A method of claim 9 where such aprotic cationic vinyl monomers comprise diallyl dialkyl ammonium cations.
